(19) United States
(12) Patent Application Publication
(10) Pub. No.: US 2023/0297704 A1
(43) Pub. Date: Sep. 21, 2023

(54) SELECTIVE REDACTION AND ACCESS CONTROL FOR DOCUMENT SEGMENTS

(71) Applicant: GCOM Software LLC, Columbia, MD (US)

(72) Inventors: Piyush Bhatnagar, Morganville, NJ (US); Andrew Ferreira, Holmdel, NJ (US)

(21) Appl. No.: 18/122,914

(22) Filed: Mar. 17, 2023

Related U.S. Application Data
(60) Provisional application No. 63/269,588, filed on Mar. 18, 2022.

(51) Int. Cl. G06F 21/62; G06F 21/60; H04L 9/08

(52) U.S. Cl. CPC G06F 21/6209; G06F 21/602; H04L 9/0819

(57) ABSTRACT

Systems and methods for selectively encrypting content segments within a document are disclosed. Also disclosed are methods for sharing such a document with other users in a way that ensures each recipient of the document can only view those content segments that correspond to the recipient's authorization level.

### CROSS-REFERENCES TO RELATED APPLICATIONS

This application claims the benefit of priority to U.S. Provisional Patent Application No. 63/269,588, filed on Mar. 18, 2022, the entire contents of which are herein incorporated by reference.

### BACKGROUND

Many systems and platforms exist via which users may share digital content. For example, document collaboration platforms allow many members of a team to work together to create and edit documents. Some platforms allow all content to be available to any user of the platform or all members of a team. Others restrict access to certain items (such as documents) to authorized users or specific team members. The platforms may manage this via access control lists, by associating documents with permission levels, or by other procedures that ensure that only users who are authorized view a document can do so.

Current access control systems typically follow an all-or-nothing approach. For example, current systems focus on the security of entire documents, and generally they cannot implement access control measures to specific sections or segments within a document. With the ever-increasing use of cloud technologies in enterprises, this issue has become even more difficult to address. In addition, existing access control systems can be breached if someone inappropriately shares a password or other user credential with someone who is not actually authorized to use the system.

This document describes methods and systems that are directed to the problems described above, and/or other issues.

### SUMMARY

This document describes systems and methods for selectively encrypting content segments within a document. The system also describes are methods for securely sharing such a document with various recipients in a way that ensures each recipient of the document can only view those content segments that are appropriate for their authorization level.

### BRIEF DESCRIPTION OF THE DRAWINGS

FIG. 1 illustrates an example system infrastructure in accordance with various embodiments.

FIGS. 2A and 2B illustrate a process by which a system will selectively redact and implement access control to various levels to individual segments within a document.

FIG. 3 illustrates an example user interface by which the system may mark document segments within a document to be protected.

FIG. 4 illustrates an example user interface by which a user may assign security levels to document content.

FIG. 5 illustrates an example process by which two devices may communicate with each other in a segment-level encryption process for a document.

FIG. 6 illustrates how a document may appear after marked content has been redacted and encrypted.

FIG. 7 illustrates an example process flow by which an authorized user may gain access to some or all marked content within a document.

FIG. 8 illustrates example components of electronic devices that may make up parts of the systems, or which may implement parts of the methods, described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and it is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

Additional terms that are relevant to this disclosure will be defined at the end of this Detailed Description section.

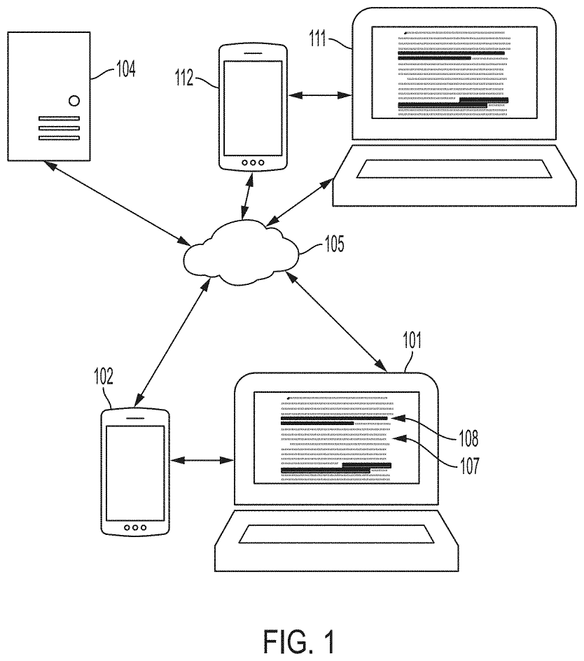

FIG. 1 illustrates an example system in which a client electronic device 102 communicates with a computing device 101 on which display is presenting a document 107 for view by a user of both devices. The client electronic device 102 and computing device 101 may be communicatively connected via a near-field communication protocol such as Bluetooth or Bluetooth Low Energy, via a short-range communication protocol, via wi-fi or other local area network, or by other communication protocols. The computing device 101 and the client electronic device 102 may be in communication with a remote server 104 via one or more communication networks 105, such as a local area network (LAN), a Wi-Fi network, a digital telecommunication network such as a wireless mobile network, and/or the Internet.

In some embodiments described below, two devices are not required, and certain embodiments may operate on a single electronic device (such as computing device 101). However, two electronic devices are used, the (second) client computing device 102 will be configured with programming instructions to run a digital identity verification application that may communicate with the server 104 and a corresponding application on the computing device 101. Example applications, and processes that such applications (along with server applications) may implement, are disclosed in U.S. Pat. No. 8,763,097 to Bhatnagar and Reddy; U.S. Pat. No. 9,412,283 to Bhatnagar; U.S. Pat. No. 9,741,033 to Bhatnagar and Ferreira; U.S. Pat. No. 9,741,265 to Bhatnagar and Ferreira; and U.S. Pat. No. 9,742,766 to Bhatnagar, the disclosures of which are all fully incorporated into this document by reference.

In the example of FIG. 1, some of the content 107 that is presented on the display of computing device 101 is masked 108 and not visible to a user of the computing device 101 or client computing device 102. Processes by which the system may selectively mask and unmask content segments for display to users of other client devices and computing devices (such as client device 112 and computing device 111) will be described below.

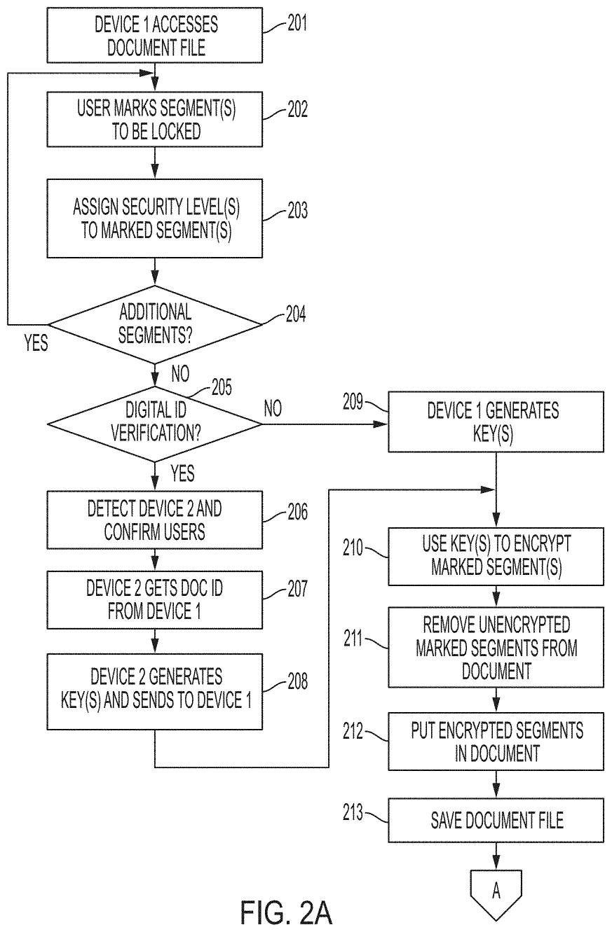

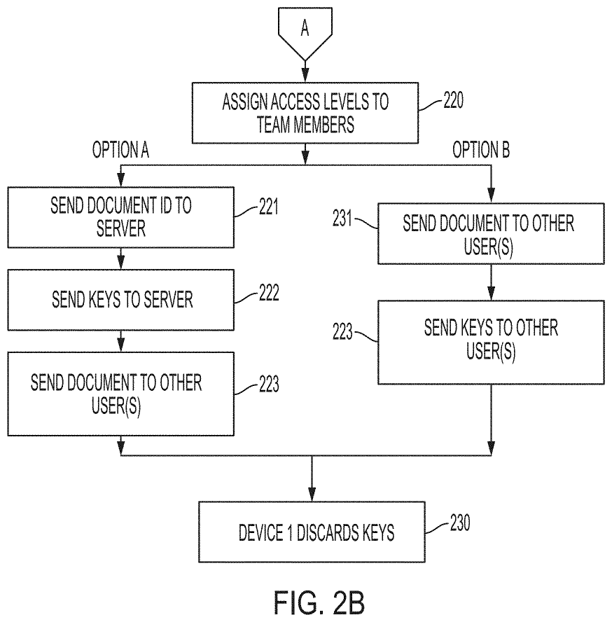

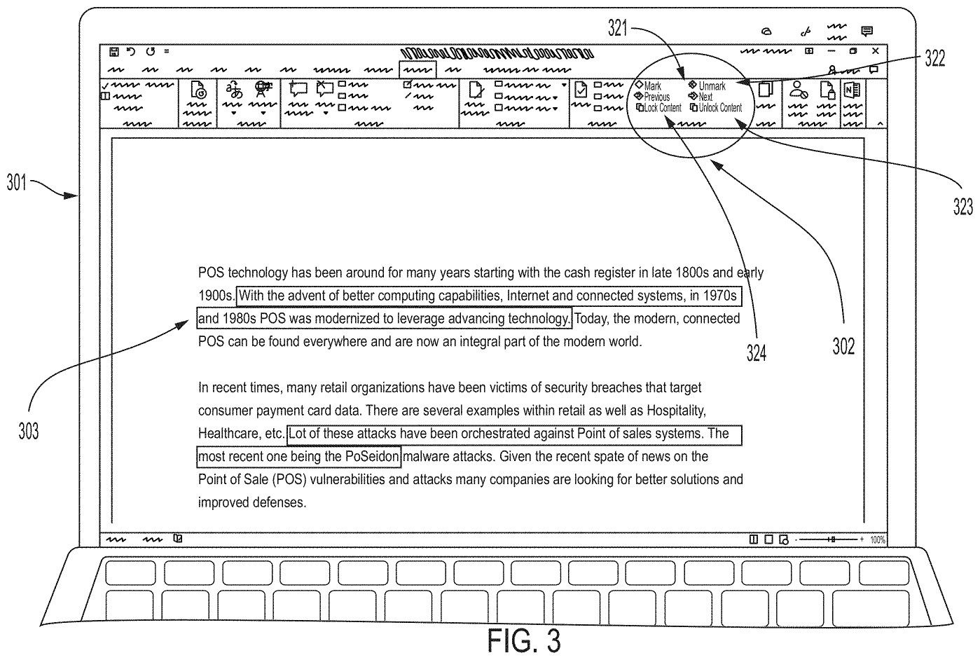

FIGS. 2A and 2B illustrate an example process flow by which a system may selectively assign security measures to various segments of a document. The method will be implemented via a document management application running on a first computing device, such as computing device 101 of FIG. 1. (For simplicity, this description may refer to the first computing device 101 as “Device 1”.) The document management application may be implemented as a module of, or plug-in to, an existing document management application such as Microsoft Word or Google Documents, or it could be a stand-alone application. An example user interface 301 of such an application with a plug-in 302 is shown in FIG. 3.

Beginning with FIG. 2A, at 201 the document management application of Device 1 accesses a document file. The document file may be one that the user creates, or one that the user retrieves from a data store. The document management application displays the document's content on a display of Device 1.

At 202 Device 1 receives a user's identification of one or more segments of the document that are to be locked, and thus marked for redaction. An example of this is shown in FIG. 3, in which the user has highlighted certain content within the document to be classified as marked content 303. The user interface also may include functions that allow a user to unmark content or changing content markings before completing the content selection process.

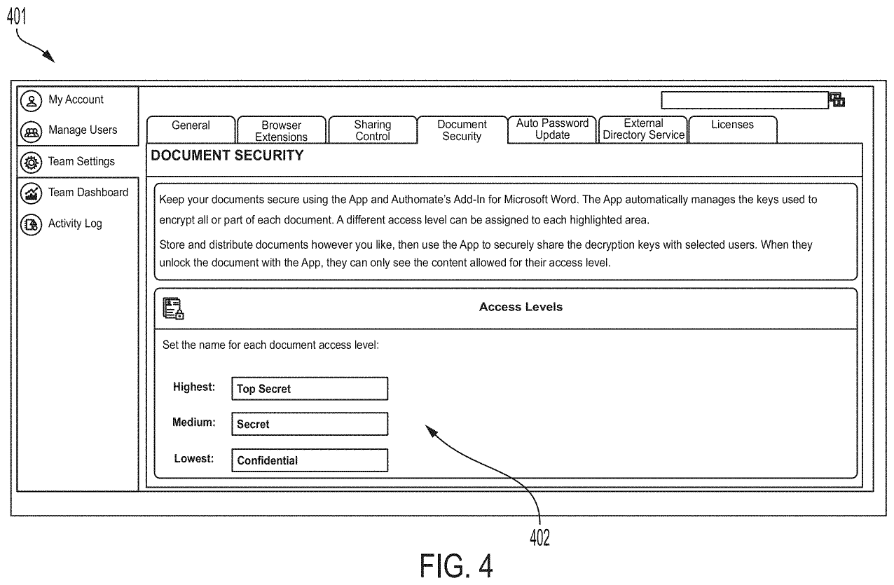

At 203 the system may assign a security level to each marked segment. The system may use the security level to determine which recipients of the document are authorized to access the marked information, as will be described in more detail below. FIG. 4 illustrates an example user interface by which the system may receive, from an administrator or a document creator, and assign user-identified security levels 401 to one or more segments of a document. As FIG. 4 shows, all marked content segments of a document may receive the same security level, or the system may assign different security levels to different marked content segments. Optionally, the system may assign a default security level to each segment, and the user may instruct the system to change security levels for any segments via an interface such as that shown in FIG. 4.

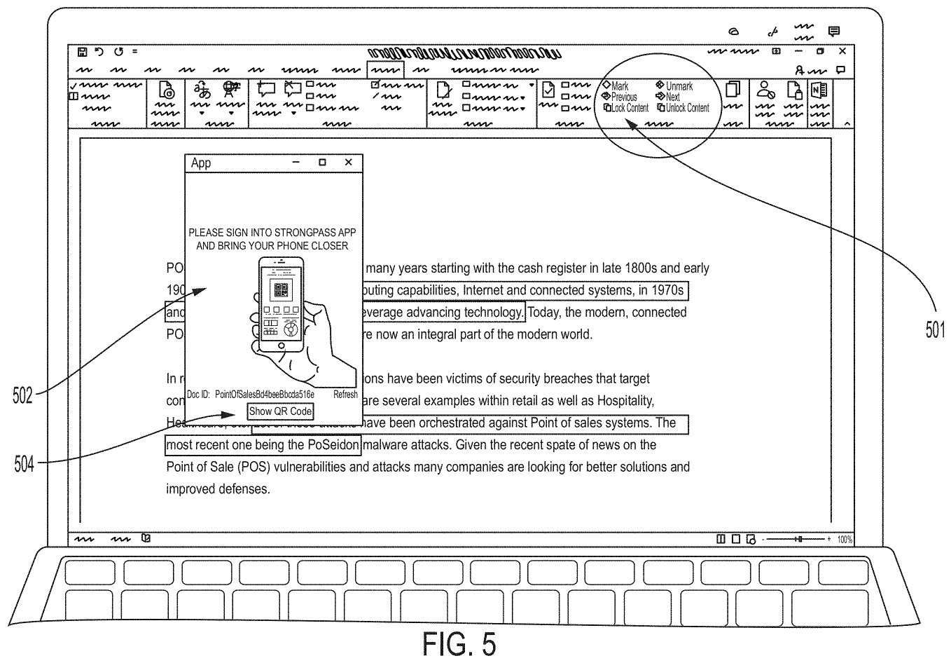

Returning to FIG. 2A, the selection of content to be locked, and the assignment of security levels, will continue (204: YES) until the system receives a user indication that the user has completed marking segments and is ready for the segments to be locked (204: NO). With reference to FIG. 5, the user indication may be, for example, actuation of a field 501 on the user interface which indicates that the user has completed marking the content, and the content is ready to be locked.

At some point in the process (whether after step 204 or earlier in the process), in embodiments that use a second computing device for digital identity verification (205: YES), Device 1 will detect that a second computing device (such as client device 102) is positioned within a communication range (optionally using a near-field or short-range communication protocol) of Device 1. (For simplicity, this description may refer to the second computing device 102 as “Device 2”.) Device 2 also will run an application that is associated with the application running on Device 1. Device 2 will use the application to store a credential of a user who is logged into the second computing device. Device 1 may request the user's credential from Device 2. If so, using a communication link between the two devices according to the communication protocol, Device 2 will transmit, and Device 1 will receive, the credential. Alternatively, Device 2 may request, Device 1 may transmit, and Device 2 may receive, the credential. At 206 Device 1, Device 2, or both will use the credentials to confirm that the same user is using both devices, using processes such as those described above in the patents incorporated by reference in FIG. 1.

Once the system detects that the two devices are proximate each other and operated by the same user, at 207 Device 2 will receive, from Device 1, a document identifier for the document file. The document identifier may be a filename, an alphanumeric code, an address, or another unique identifier. Device 1 may pass the document identifier to the first computing device via the communication link. Alternatively, Device 1 may encode the document identifier into a displayable code (such as a QR code) and output the displayable code on its display. If so, Device 2 may use a camera to capture an image the code. Device 2 may then use any suitable decoding method to decode the code and yield the document identifier. As shown in FIG. 5, the application on Device 2 (or the plug-in on Device 1) may generate a prompt 504 via which the user may command Device 1 to display the code or otherwise transfer the document identifier from Device 1 to Device 2.

At 208 the application running on Device 2 will generate one or more encryption keys for the marked content, and Device 2 will send the encryption keys to Device 1. If the document includes content marked with different security levels, Device 2 may generate and send individual keys for each security level. If symmetric encryption is used, Device 2 may generate a single key for each security level and send that key to Device 1. If asymmetric encryption is used, Device 2 may generate both a public key and a private key for each security level, and Device 2 will send the public key (but not the private key) to Device 1.

In embodiments that do not use a second computing device for digital identity verification (205: NO), then instead of steps 206-208 in which Device 2 generates the key(s) and sends the key(s) to Device 1, at 209 Device 1 will generate the encryption key or keys.

At 210, upon generation or receipt of an encryption key, Device 1 will use the encryption key to encrypt the marked segments into one or more encrypted segments. If multiple keys are used, then the system may select, for each segment, the key having an associated security level that corresponds to the segment's assigned security level. The system may group marked segments that share a common security level together in a single ciphertext element, or the system may generate separate ciphertext elements for each of the marked segments.

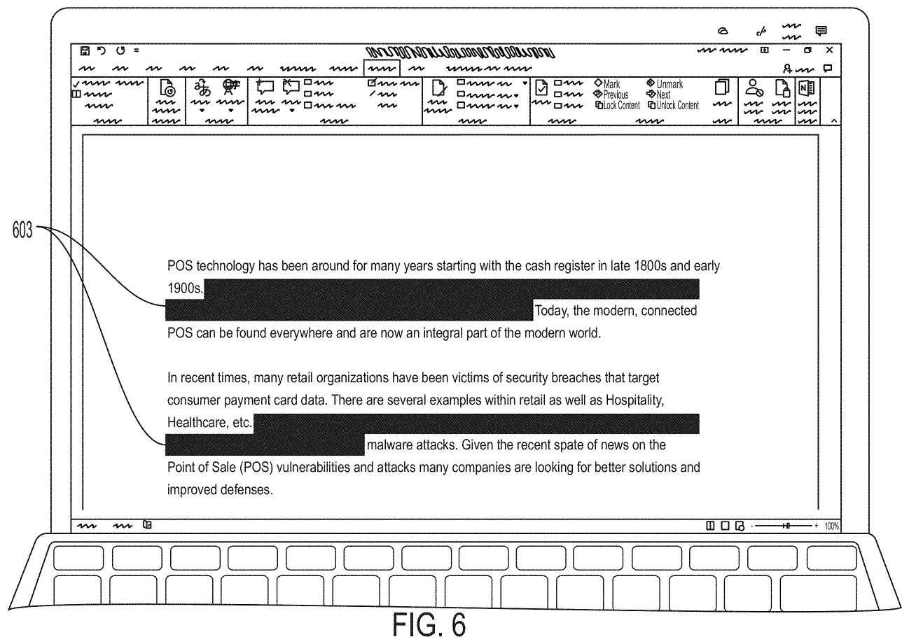

At 211 Device 2 will remove the unencrypted versions of the marked segments from the document file. FIG. 6 illustrates an example document in which the marked content 601 has been removed and replaced with redaction marks. At 212 Device 2 may modify the document file (or generate a new document file) to store the encrypted segments (i.e., the ciphertext) to the document file, such as in a header of the document file and/or as metadata within the file. Alternatively, the system may store the encrypted segments in a separate file that is associated with the document file; however, saving the encrypted segments within the document file itself can help provide for easier sharing of the document among a group of users who may be authorized to access some or all of the marked content. At 213 Device 2 will then save the document file with the modifications described above, locally and/or in a remote data storage facility.

Continuing the process with reference to FIG. 2B, at 220 the document creator, an administrator may assign access levels to various recipients of the document, or the system may assign a default access levels to recipients. This may be done at any time in the process of FIGS. 2A-2B, or even independently from the process of FIGS. 2A-2B, including before the document is marked or after the document is marked. Optionally, each recipient may be given the lowest possible access level (and thus will receive no keys to decrypt marked segments) unless the document creator or an administrator grants a higher access level to that recipient. Optionally, the system may send the access levels to a remote server so that the remote server may store a data set of access levels for each authorized user. When a recipient of the document then accesses the document, the system may only display the content that the recipient is authorized to see, and marked content having a security level that is higher than the recipient's access level may be redacted and not shown to that user.

Once the encryption is complete and the document file with created, Device 1 may transfer the document file to other users in one of multiple ways.

In a first option (denoted as Option A in FIG. 2B), at 221 either Device 1 or Device 2 may send the document ID to a remote service such as server 104 of FIG. 1. At 222 one of the devices also will send the encryption or keys to the remote service. If asymmetric encryption was used, the encryption keys will be private keys that Device 2 generated, and Device 2 will share the keys and document identifier with the service. If symmetric encryption was used, then either of the devices may share the keys and document identifier with the service. At 223 Device 1 will then transmit a copy of the document file to the other users, either directly via a messaging service or indirectly by sending the document file to a file transfer service where the other users may retrieve it. The file transfer site may be same service that stores the keys, or it may be a service that stores the keys.

In a second option (denoted as Option A in FIG. 2B), at 231 Device 1 may send the document file to other users, either directly via a messaging service or indirectly by sending the document file to a file transfer service where the other users may retrieve it. At 232 Device 1 will also send each recipient of the document file only the keys that will unlock the content marked with a security level that corresponds to that user's access level, and no keys for other security levels.

Thus, with the process above, when a recipient of the document accesses the document, the recipient will only receive the keys having a security level that corresponds to the recipient's access level. The system will then only display the content that the recipient is authorized to see, and marked content having a security level that is higher than the recipient's access level may be redacted and not shown to that user.

Optionally, the system may include a user interface that enables a document creator or administrator to remove or reduce the access level granted to any recipient of a document. When this happens, the application running on the recipient's device will delete any keys that do not correspond to the user's revised access level.

Once encryption is complete and Device 1 no longer needs the keys for any steps described above, Device 1 will then discard the keys at 230.

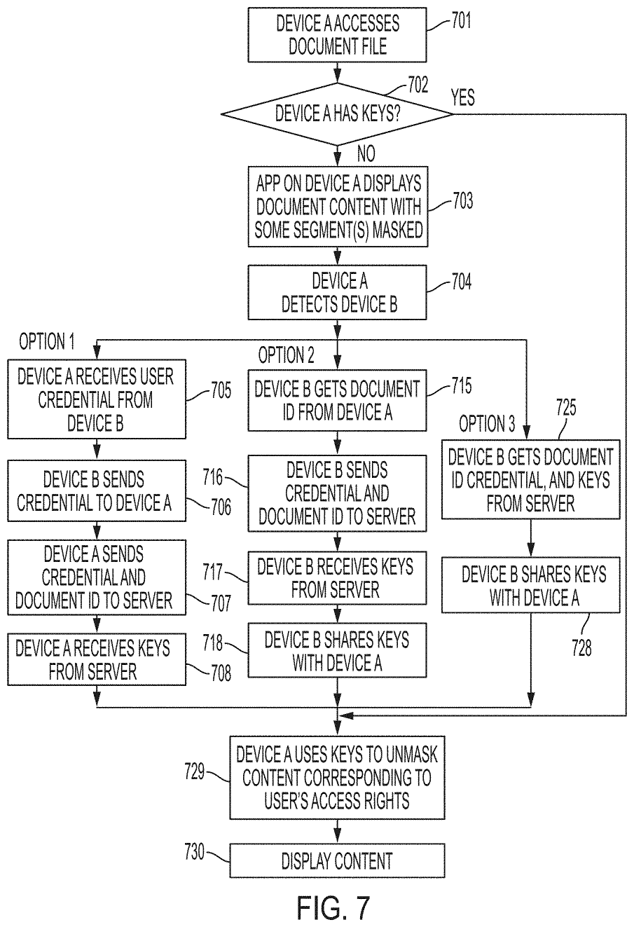

FIG. 7 illustrates a process by which the system will select which marked segments to display to a user, according to the user's access level. At 701 the application will cause a first computing device to access a document file containing a collection of content, in which some of the collection of content is marked to be locked. The document file will be created using the process described above. Therefore, the marked content will be stored as ciphertext within the document file's metadata and/or file header, and the remainder of the document (i.e., that which is not marked content) will include one or more indicators or fields indicating where the marked content should be inserted when it is unencrypted. For purposes of this disclosure, the first computing device may be one such as computing device 101 of FIG. 1. However, the first computing device used in the process flow of FIG. 7 does not necessarily need to be the same computing device as that used in the encryption process (such as Device 1 of FIG. 1). Instead, it can be a different device, such as computing device 111 of FIG. 1. Therefore, for brevity and clarity, in this description of FIG. 7 we will refer to the first computing device as “Device A” and the second computing device as “Device B” for brevity.)

If Device A received the keys with the document (702: YES) as in step 223 (Option B) of FIG. 2B, then at 729 Device 1 may then unmask the marked content that is associated with the user's access level by using the received encryption key or keys to decrypt some or all of the ciphertext stored in the document file. The system may then display a version of the document in which the unmasked content is visible to the user at 720.

If Device A did not receive the keys with the document (702: NO) at 703 the application will cause a display of Device A to display the document but will mask the marked content and not make the marked content visible on the display until the device user's access level has been confirmed. The masking may be done by redaction, in which the marked content is replaced or overlaid with a solid line, as with redacted content 601 of FIG. 6. Other masking methods may include, without limitation, inserting a blank in the location where the marked content would appear, or replacing the marked content with random or nonsense characters.

At 704 Device A will detect that a second computing device is positioned within a communication range (optionally using a near-field or short-range communication protocol) of Device A. The second computing device also will run an application that is associated with the application running on the first computing device. For purposes of this disclosure, the second computing device may be one such as client device 102 of FIG. 1, and in this discussion of FIG. 7 we will refer to the second computing device as “Device B”. However, the second computing device used in the process flow of FIG. 7 does not necessarily need to be the same client device as that used in the encryption process (i.e., client device 102 of FIG. 1 and Device A of FIG. 2). Instead, it can be a different device, such as client device 112 of FIG. 1.

Device A may determine the user's access level, and thus determine which marked content to unmask for the user, in any of various ways. Two example process flows are shown in FIG. 7.

In a first possible process flow (identified as “Option 1” on the left side of FIG. 7), at 705 and 706 Device A requests and receives a user credential from Device B. At 707 Device A sends one or more messages with the user credential and the document identifier for the document to a remote server (such as server 104 of FIG. 1) that serves as an orchestration engine. The server will include or have access to a data store that associates user credentials with documents and access levels, to provide a data set that identifies the security level that each user has been assigned for any given document. The data store may be in a form such as a database, an access control list, or other structure. The data store also will store, for each document, the keys that Device A may use to decrypt the marked content within the document. The server will send Device A the stored encryption keys that correspond to the user's access level, and Device A will receive those keys at 708.

In a second possible process flow (identified as “Option 2” on the right side of FIG. 7), at 715 Device B receives a document identifier for the document from Device A. Device B may receive the document identifier via a message transmitted between the communications via the communication protocol described above, or by reading and decoding a code that Device A displays, such as a QR code as described in previous processes above. At 715 Device B sends one or more messages with the user credential and the document identifier to the remote server/orchestration engine. As noted above, the server will include or have access to a data store that associates user credentials with documents and access levels. The data store also will store, for each document, the keys that Device A may use to decrypt the marked content within the document. At 717 the server will send, and Device B will receive, the stored encryption keys that correspond to the user's access level. At 718 Device B will pass the encryption key or keys to Device A via the communication path described above.

After either the Option 1 process flow or Option 2 process flow described above, after Device A receives the relevant encryption key or keys, at 729 Device A may then unmask the marked content that is associated with the user's access level by using the received encryption key or keys to decrypt some or all of the ciphertext stored in the document file. The system may then display a version of the document in which the unmasked content is visible to the user at 720.

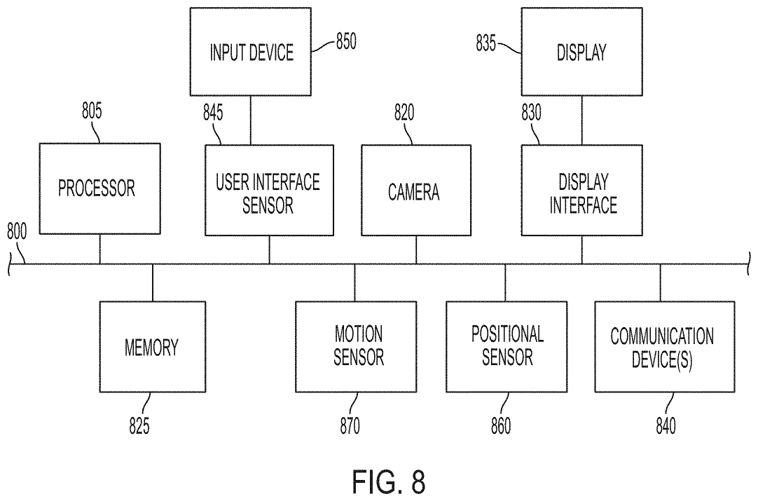

FIG. 8 depicts an example of internal hardware that may be included in any of the electronic components of the system such as the computing devices 101 and 111, the client electronic devices 102 and 112, and/or the remote server 104 that operates as an orchestration engine. An electrical bus 800 serves as an information highway interconnecting the other illustrated components of the hardware. Processor 805 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 825. A memory device may include a single device or a collection of devices across which data and/or instructions are stored.

An optional display interface 830 may permit information from the bus 800 to be displayed on a display device 835 in visual, graphic or alphanumeric format. An audio interface and audio output (such as a speaker) also may be provided. Communication with external devices may occur using various communication devices 840 such as a wireless antenna, a radio frequency identification (RFID) tag and/or short-range or near-field communication transceiver, each of which may optionally communicatively connect with other components of the device via one or more communication systems. The communication device 840 may be configured to be communicatively connected to a communications network, such as the Internet, a local area network or a cellular telephone data network.

The hardware may also include a user interface sensor 845 that allows for receipt of data from input devices 850 such as a keyboard, a mouse, a joystick, a touchscreen, a touch pad, a remote control, a pointing device and/or microphone. Digital image frames also may be received from a camera 820 that can capture video and/or still images. The system also may include a positional sensor 880 and/or motion sensor 870 to detect position and movement of the device. Examples of motion sensors 870 include gyroscopes or accelerometers. Examples of positional sensors 880 include a global positioning system (GPS) sensor device that receives positional data from an external GPS network.

Terminology that is relevant to this disclosure includes:
An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 8.

In this document, the terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, the term “electrically connected”, when referring to two electrical components, means that a conductive path exists between the two components. The term “communicatively connected”, when referring to two devices, means that a communication path exists between the two components. In either case, the path may be a direct path, or an indirect path through one or more intermediary components.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of controlling access to one or more segments of a document, the method comprising. by a system comprising a first computing device and a second computing device:
by the first computing device:
displaying, on a display, a document comprising content,
receiving, via a user interface, a user selection of a first segment of the content as marked content, and
assigning a security level to the marked content;
by the second computing device, when proximate and within a communication range of the first computing device:
generating one or more encryption keys for the marked content,
passing the one or more encryption keys to the first computing device;
by the first computing device,
using the one or more encryption keys to encrypt the marked content, yielding encrypted content, and
saving the content to a document file, in which the document file includes the marked content only in encrypted form and not in unencrypted form; and
sending either (a) one or more of the encryption keys with a document identifier for the document to a server, or (b) one or more of the encryption keys and the document file to a recipient.

2. The method of claim 1, further comprising:
by the second computing device, receiving the document identifier from the first computing device; and
wherein sending the one or more of the encryption keys with the document identifier for the document to the server is performed by the second computing device.

3. The method of claim 1, wherein receiving the document identifier from the first computing device comprises:
capturing an image of the display of the first computing device while the display is outputting a code in which the document identifier is encoded; and
decoding the code to yield the document identifier.

4. The method of claim 1 further comprising, by the first computing device after using the one or more encryption keys, discarding the one or more encryption keys.

5. The method of claim 1, further comprising:
by the first computing device, while displaying the document:
receiving, via a user interface, a user selection of one more additional segments the content as additional marked content segments, and
assigning security levels to each of the additional marked content segments, wherein the assigned security levels comprise a plurality of security levels; and
by the second computing device, when generating the one or more encryption keys for the marked content, generating one or more encryption keys for each of the assigned security levels.

6. The method of claim 5, further comprising, by the first computing device, encrypting each of the additional marked content segments using the encryption key that was generated for the security level that is assigned to that additional marked content segment.

7. The method of claim 1, wherein saving the content to a document file comprises saving the marked content in encrypted form as metadata in the document file.

8. The method of claim 1 further comprising:
sending the document file to one or more users;
assigning an access level to each of the one or more users, wherein the access level corresponds to the security level; and
sending the access levels for each of the one or more users to the remote server.

9. A method of gaining secure access to one or more marked segments of a document, the method comprising, by a system comprising a first computing device and a second computing device:
by the first computing device, accessing a document file comprising content, in which one or more segments of the content are redacted and included only as encrypted content;
detecting that a second computing device is proximate and within a communication range of the first computing device;
sending, to a remote server, a document identifier for the document and a user credential for a user of the second computing device;
receiving, from the remote server, an encryption key; and
by the first computing device:
using the encryption key to decrypt one or more of the segments that are encrypted content, yielding one or more unmasked segments, and
causing a display of the first computing device to display the document with the one or more unmasked segments.

10. The method of claim 9, further comprising:
by the first computing device, receiving the user credential from the second computing device; and
wherein sending the document identifier and the user credential to the remote server is performed by the first computing device.

11. The method of claim 9, further comprising:
by the second computing device, receiving the document identifier from the first computing device; and
wherein sending the document identifier and the user credential to the remote server is performed by the second computing device.

12. The method of claim 9, wherein receiving the document identifier from the first computing device comprises, by the second computing device:
capturing an image of the display of the first computing device while the display is outputting a code in which the document identifier is encoded; and
decoding the code to yield the document identifier.

13. The method of claim 9, wherein:
the one or more segments of the content that are included only as encrypted content comprise a plurality of segments, each of the plurality of segments is associated with a security level, and the associated security levels comprise a plurality of security levels;
receiving the encryption key comprises receiving a plurality of encryption keys, each of which is associated with one of the security levels; and
when the first computing device uses the encryption key to decrypt any segment that has been encrypted, the system uses the encryption key having a security level matching the security level for that segment.

14. A method of controlling access to one or more segments of a document, the method comprising. by a computing device:
displaying, on a display, a document comprising content;
receiving, via a user interface, a user selection of a first segment of the content as first marked content and a second segment of the content as second marked content;
assigning a first security level to the first marked content and a second security level to the second market content;
accessing a first encryption keys for the first security level and a second encryption key for the second security level;
using the first encryption key to encrypt the first marked content, yielding first encrypted content,
using the second encryption key to encrypt the second marked content, yielding second encrypted content;
saving the content, the first encrypted content and the second encrypted content to a document file, in which the document file includes the marked content only in encrypted form and not in unencrypted form;
identifying an access level of a recipient;
selecting, from the first encryption key and the second encryption key, a key that corresponds to the access level of the recipient; and
sending the selected encryption key and the document file to the recipient.
